(19) United States
(12) Patent Application Publication
(10) Pub. No.: US 2006/0179285 A1
(43) Pub. Date: Aug. 10, 2006

(54) Type conversion unit in a multiprocessor system

(76) Inventor: Marco Jan Gerrit Bekooij, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/549,215

(22) PCT Filed: Mar. 17, 2004
(86) PCT No.: PCT/IB04/50268

§ 371 Date: Sep. 14, 2005

(30) Foreign Application Priority Data
Mar. 19, 2003 (EP) 031007081

(51) Int. Cl. G06F 9/44

(52) U.S. Cl. 712/225

(57) ABSTRACT

The invention relates to a very large instruction word (VLIW) processor, comprising a plurality of execution units (101, 103,105), a register file (109, 111, 113) and a communication network (117) for coupling the execution units and the register file. In case of an application specific VLIW processor, i.e. a VLIW processor designed for handling a specific range of applications, the communication network of the VLIW processor may not support all types of data conversions. Therefore, it may turn out that a certain data type conversion is not possible for some applications to be run on such a VLIW processor. By incorporation a type conversion unit (107) in the architecture of the VLIW processor, it can be guaranteed that any desired data type conversion can be performed. In case of a partially connected communication network (117), a communication device (129) can be incorporated as well in the architecture, allowing every execution unit to transfer a value to the type conversion unit, and allowing the type conversion unit to transfer a value to any segment of the distributed register file.

The invention relates to a processor comprising a plurality of execution units, a register file accessible by the execution units and a communication network for coupling the execution units and the register file.

The ongoing demand for an increase in high performance computing has let to the introduction of several solutions in which some form of concurrent processing, e.g. parallelism has been introduced into the processor architecture. A widely used concept to achieve high performance is the introduction of instruction level parallelism, in which a number of execution units are present in the processor architecture for executing a number of instructions more or less at the same time. Two main concepts have been adopted: the multithreading concept, in which several threads of a program are accessible by the execution units, and the very large instruction word (VLIW) concept, in which bundles of instructions corresponding with the functionality of the execution units are present in the instruction set.

In case of a Very Large Instruction Word (VLIW) processor, multiple instructions are packaged into one long instruction, a so-called VLIW instruction. A VLIW processor uses multiple, independent execution units to execute these multiple instructions in parallel. The processor allows exploiting instruction-level parallelism in programs and thus executing more than one instruction at a time. In order for a software program to run on a VLIW processor, it must be translated into a set of VLIW instructions. The compiler attempts to minimize the time needed to execute the program by optimizing parallelism. The compiler combines instructions into a VLIW instruction under the constraint that the instructions assigned to a single VLIW instruction can be executed in parallel and under data dependency constraints. Encoding of instructions can be done in two different ways, for a data stationary VLIW processor or for a time stationary VLIW processor, respectively. In case of a data stationary VLIW processor all information related to a given pipeline of operations to be performed on a given data item is encoded in a single VLIW instruction. For time stationary VLIW processors, the information related to a pipeline of operations to be performed on a given data item is spread over multiple instructions in different VLIW instructions, thereby exposing said pipeline of the processor in the program.

In most high-level programming languages multiple data-types can be used. In programs using C as the programming language, a data type is often implicitly converted or explicitly casted to another data-type. When executing the program, the actual type conversion may then be performed in the network of the VLIW processor, or at the output of an execution unit. In case of an application specific VLIW processor, i.e. a VLIW processor designed for handling a specific range of applications, the network of the VLIW processor or the execution unit may not provide the required type conversion hardware for all data type conversions. Therefore, it may turn out that a certain data type conversion can not be performed for some applications to be run on such a VLIW processor.

U.S. Pat. No. 6,460,135 describes a microprocessor comprising an input/output execution unit, a calculation execution unit, a plurality of data registers, an instruction controller and an interconnect structure. The instruction controller decodes the instruction word and sends the operation code to the input/output execution unit or the calculation execution unit. Type information registers are associated with the data registers and an information register holds the type information indicating the data type and the effective bit width of the data stored in the corresponding data register. The instruction word designates the type information of the execution result, i.e. the data type and the effective bit width, independently of the type information of the data used for the calculation. During execution of an operation requiring two operands, the calculation execution unit compares the type information of the two operands, and in case a disagreement exists, an interrupt is generated and subsequently data is converted to the correct type and this conversion is done in software. In case the input/output execution unit has to execute an input/output instruction, it compares the type information stored in the type information register with that of the instruction word. In case of disagreement, an interrupt is generated as well and subsequently the data is also converted to the correct type and this conversion is done in software.

It is a disadvantage of the prior art processor that an interrupt has to be generated in order to initiate the type conversion, which subsequently has to be performed in software. As a result, the overall performance of the processor may decrease substantially.

It is an object of the invention to increase the range of data type conversions that can be performed in an application specific multiprocessor system, and more in particular in an application specific VLIW processor, increasing the flexibility of those systems.

This object is achieved with a processor of the kind set forth, characterized in that the processor further comprises a conversion device for converting the type of data when transferring said data between an execution unit of the plurality of execution units and the register file. In case the communication network does not support the required data type conversion, the type conversion can be performed by the conversion device. By allowing the conversion device to perform a broad range of type conversions, the flexibility of an application specific multiprocessor system can be increased since different applications, i.e. applications outside the original range of applications, can be run on the multiprocessor system as well.

An embodiment of the invention is characterized in that the register file is a distributed register file, and that the communication network is a partially connected communication network for coupling the execution units and selected parts of the distributed register file. An advantage of a distributed register file is that it requires less read and write ports per register file segment, resulting in a smaller register file bandwidth Furthermore, the addressing of a register in a distributed register file requires less bits when compared to a central register file. A partially connected communication network is less expensive in terms of code size and power consumption, when compared to a fully connected communication network, especially in case of a large number of execution units.

An embodiment of the invention is characterized in that the conversion device comprises a conversion register file and a conversion unit, the conversion register file being accessible by the conversion unit. In case the result of an execution unit has to be written to several registers of the register file, but with a different data type, the data can be written to the conversion register file. Subsequently, the conversion unit can read the data from the conversion register file, convert the data into the required type, and write the results to the appropriate register, for each request.

An embodiment of the invention is characterized in that the processor further comprises a communication device for coupling the execution units, the conversion unit, the distributed register file, and the conversion register file. In case of a partially connected communication network, it can not be guaranteed that there exists a communication path from every execution unit or type conversion unit output to every execution unit or type conversion unit input. As a result, an execution unit may not be able to transfer data to the conversion unit The communication device allows transferring data from the execution unit output to the conversion unit, and also from the conversion unit to the execution unit input, in case this is not possible via the communication network.

An embodiment of the invention is characterized in that the communication device supports all data types of a programming language. An advantage of this embodiment is that all data can be transferred to the conversion device for data type conversion, independent of its type and without requiring any intermediate conversion by the communication network or the communication device itself.

An embodiment of the invention is characterized in that the communication device couples all execution units, the conversion unit, all parts of the distributed register file, and the conversion register file. An advantage of this embodiment is that all execution units can transfer data to the conversion register file via the communication device, and that the conversion unit can always transfer data to all register file segments via the communication device.

An embodiment of the invention is characterized in that the conversion unit is part of one of the execution units of the plurality of execution units. An advantage of this embodiment is that no separate conversion unit is required, saving additional silicon area as well as communication connections.

### BRIEF DESCRIPTION OF THE DRAWING

FIG. 1 shows a processor, comprising a plurality of execution units, according to the invention.

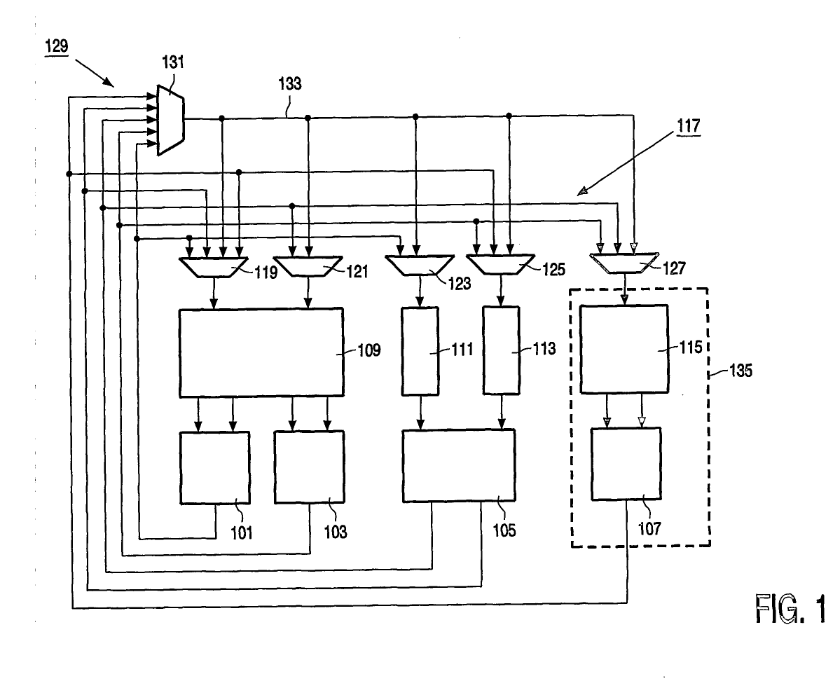

Referring to FIG. 1, a schematic block diagram illustrates a VLIW processor, comprising a plurality of execution units 101, 103 and 105, and a distributed register file, including the register file segments 109, 111, 113. The processor also has a conversion device 135. Conversion device 135 comprises conversion register file 115 and type conversion unit 107. Register file segment 109 is accessible by execution units 101 and 103, register file segments 111 and 113 are accessible by execution unit 105 and conversion register file 115 is accessible by type conversion unit 107.

The processor also has a partially connected network 117 for coupling the execution units 101, 103 and 105, and selections of distributed register file segments 109, 111, 113 and conversion register file 115. The partially connected network 117 also couples conversion device 135 with selected distributed register file segments 109, 111 and 113. The partially connected network 117 comprises the multiplexers 119, 121, 123, 125 and 127. The processor handles a specific range of applications, and the partially connected network 117 is designed for this purpose, i.e. during design of the processor a connection from an execution unit to a distributed register file segment is made via the partially connected network, if that execution unit has to write values into that register file segment during execution of an application within that range. Especially in case of a large number of execution units, connecting all execution units to all distributed register file segments via a direct connection will be too expensive in terms of silicon area and multiplexing overhead. During design time also the connections, part of the partially connected network 117, between the execution units 101, 103 and 105, and the conversion register file 115, as well the connections, being part of the partially connected network 117, between the type conversion unit 107 and distributed register file segments 109, 111 and 113 are fixed. The partially connected network 117 also supports a number of data type conversions itself, and which type conversions are supported is fixed during design of the processor as well

During execution of an application by the processor, data type conversions will have to be performed by the processor. For example, execution unit 101 produces an output in the form of an unsigned fixed point number, comprising 16 bits from which 15 bits are positioned behind the decimal point, that has to be written to register file segment 111, via the partially connected network 117. Execution unit 105 will use this data output as input for an operation, but this input is required to be an unsigned fixed number, comprising 32 bits from which 31 bits are positioned behind the decimal point. Therefore, the type of the data will have to be converted. In this case, the partially connected network supports this data type conversion, and the unsigned fixed point number comprising 16 bits is implicitly converted by the multiplexer 123 to an unsigned fixed point number comprising 32 bits.

When executing an application that is outside the range for which the processor is originally designed, it may turn out that a required data type conversion can not be performed implicitly by the processor. For example, execution unit 103 produces a data output in the form of an unsigned fixed point number, comprising 16 bits, that should be written to register file segment 113, via the partially connected network 117. Execution unit 105 requires these data as input data for an operation, as floating point number comprising 32 bits. However, multiplexer 125 is not capable of converting the type of the data from an unsigned fixed point number to a floating point number. In this case, execution unit 103 writes the data to conversion register file 115, via the partially connected network 117. Type conversion unit 107 reads the data from register file segment 115, and this unit converts the type of the data from unsigned fixed point number to floating point number, by executing a dedicated instruction. Subsequently, type conversion unit 107 writes the data in the form of a floating point number to register file segment 113, via the partially connected network 117. Now the data are available in the correct data type for execution unit 105.

Another possibility is that during execution of an application, outside the range for which the processor is originally designed, an execution result is used as input data by more than one execution unit, but these execution units require a different data type. Performing the same operating twice, and producing an output result with a different type is not possible if the execution unit comprises an internal state. For example, in case of a Multiply Accumulation Unit having an internal accumulation register, performing two subsequent identical operations with the same input data will result in a different output result. For example, execution unit 105 produces output data in the form of an unsigned fixed point number comprising 32 bits, and these data have to be written twice to register file segment 109, via the partially connected network 117, once as an unsigned fixed point number comprising 16 bits and once as a floating point number comprising 32 bits. Subsequently, these data are required as input data for execution units 101 and 103, respectively. However, the partially connected network 117 can not perform both of the required data type conversions. Execution unit 105 writes its output data to conversion register file 115, via the partially connected network 117. Execution unit 107 reads the data from conversion register file 115, converts the data from an unsigned fixed point number comprising 32 bits to an unsigned fixed point number comprising 16 bits, and writes the converted data to register file segment 109, via the partially connected network 117. Next, execution unit 115 reads the data again from conversion register file 115, converts the data from an unsigned fixed point number comprising 32 bits to a floating point number comprising 32 bits, and writes the converted data to register file segment 109, via the partially connected network 117. Subsequently, these data can be read by execution units 101 and 103 from register file segment 109, and used for further processing.

For some applications executing on the processor, writing data from the execution units 101, 103 and 105 to the conversion register file 115 or writing data from the type conversion unit 107 to register file segments 109, 111 and 113 may require more than one step. For example, execution unit 101 produces output data of type floating point number, and this data has to written to register file segment 111 as an unsigned fixed point number, to be used as input data for an operation to be performed by execution unit 105. However, the partially connected network does not support this type conversion. The type conversion can be performed by type conversion unit 107, but execution unit 101 can not write directly its output data to register file segment 115, via the partially connected network 117, but only via an alternative route. A possible alternative route is that execution unit 101 writes its output data to register file segment 111, via the partially connected network 117, without implicit data type conversion. Execution unit 105 reads the output data from register file segment 111, and write these output data to register file segment 115, via the partially connected network 117. Subsequently, type conversion unit 107 reads the output data from register file segment 115 and performs the required data type conversion. Type conversion unit 107 is not capable of writing the data directly to register file segment 111, via the partially connected network 117, but only via an alternative route. A possibility is that type conversion unit 107 writes the data to register file segment 109, via the partially connected network 117. Subsequently, the data are read from the register file segment 109 by execution unit 101, who writes the data to register file segment 111, via the partially connected network 117. In case during compilation of a program the compiler detects that data cannot be written directly by an execution unit to the conversion register file, or by the type conversion unit directly to a register file segment, it will determine an alternative route and inserts the required additional instructions in the program.

In case the partially connected network 117 is not capable of performing the desired type conversion, the type conversion unit 107 can perform this type conversion and write the converted data to the proper register file segment via the partially connected network. As a result, the processor can still efficiently execute applications outside the range for which the processor was originally designed, increasing the flexibility of the processor. During compilation of such application, the compiler will detect that a required data type conversion can not be performed implicitly by the network, and introduces additional instructions in the program for sending the data to the type conversion unit 107, via the partially connected network 117, converting the data to the required data type by the type conversion unit 107, and sending the converted data to the required register file segment, via the partially connected network 117. The explicit type conversion performed by the type conversion unit 107 can be implemented by means of one or more operations, as known by the person skilled in the art. For example, when only using unsigned fixed point types, a shift left operation, a shift right operation and an AND operation will suffice. In case of signed fixed point types it should be possible to add bits as most significant bits in case of a shift right operation, in order to prevent a change of the sign bit.

In another embodiment the communication network 117 may be a fully connected communication network, i.e. all execution units 101, 103 an 105, and type conversion unit 107 are coupled to all distributed register file segments 109, 111 and 113, and the conversion register file 115. In case of a relatively small number of execution units, the overhead of a fully connected communication network will be relatively small.

In alternative embodiments, the processor also comprises a communication device 129 for coupling the functional units 101, 103 and 105, type conversion unit 107, and all distributed register file segments 109, 111 and 113, and conversion register file 115. The communication device 129 shares multiplexers 119, 121, 123, 125 and 127 with the partially connected network 117. The communication device support all data types for the programming language in which the application to be executed is written.

In some situations, it may turn out that the partially connected network 117 can not implicitly perform a required type conversion. On top of that, an alternative route for writing the data to conversion register file 115 of type conversion unit 107, or writing the data from type conversion unit 107 to register file segments 109, 111 and 113 may require many steps or even does not exist. In these cases, the communication device 129 allows transferring values between the execution units 101, 103 and 105, the type conversion unit 107, the distributed register file segments 109, 111 and 113, and the conversion register file 115, in case this is not possible via the partially connected network 117. In this way a communication path between each output of the execution units 101, 103, 105, and type conversion unit 107, and each input of the execution units 101, 103 and 105, and type conversion unit 107 is guaranteed to exist. For instance, execution unit 101 is not directly coupled to register file segment 115 via the partially connected network 117, but a direct coupling only exists via communication device 129. If possible, however, direct communication between the execution units, type conversion unit and register files via the partially connected network 117 is preferred.

For example, execution unit 101 produces result data as an unsigned fixed point number comprising 32 bits, and these data have to be written to register file segment 111, for subsequent use by execution unit 105, which requires data as floating point number as input data. Execution unit 101 can not write the data directly to register file segment 111 via the partially connected network 117 since it does not support this type of data conversion. Execution unit 101 can also not write the output data directly to register file segment 115 via the partially connected network 117, as this connection does not exist. On top of that, type conversion unit 107 can also not write data directly to register file segment 111 via the partially connected network 117, since this connection also does not exist. The compiler detects these problems during program compilation, decides to transfer data via the communication device 129, and inserts the appropriate instructions for performing these data transfers in the program. The execution unit 101 writes the output data to register file segment 115, via communication device 129. Subsequently, the type conversion unit 107 reads the data from conversion register file 115 and converts the type of the data to a floating point number. Subsequently, type conversion unit 107 writes the data to register file segment 111, via communication device 129. In alternative embodiments, data may be written from execution units 101, 103 and 105 to conversion register file 115 via the partially connected network 117, and subsequently from type conversion unit 107 to register file segments 109, 111 and 113 via communication device 129. In another embodiment data may be written from execution units 101, 103 and 105 to conversion register file 115 via communication device 129, and subsequently from type conversion unit 107 to register file segments 109, 111 and 113 via the partially connected network 117.

Preferably, the communication device 129 is arranged for communication with a first latency, the partially connected communication network 117 is arranged for communication with a second latency, the first latency exceeding the second latency. An advantage of this embodiment is that it prevents the communication via the communication device 129 from being the rate-limiting step, so that it allows the processor to run at maximal clock frequency. Furthermore a high throughput is realized. Usually, the communication device 129 comprises a form of shared communication mechanism. Therefore, the communication via the communication device 129 may be slow down by its control logic, especially in case of a large number of execution units. Dividing the communication via the communication device into several sequential steps, each of which takes place in one clock cycle, keeps the latency of one communication step low. This prevents the communication via the communication device to limit the clock frequency of the processor. The total latency of the communication via the communication device, being the sum of the latencies of all separate steps, will be higher than the latency of the communication via the partially connected communication network. However, the higher latency of the communication via the communication device 129 will hardly affect the overall performance of the processor, since the majority of the communication will take place via the partially connected communication network 117.

In an advantageous embodiment, the communication device 129 comprises a multiplexer 131 and a global bus 133, the multiplexer being arranged for coupling the functional units 101, 103 and 105, type conversion unit 107, and the global bus 133, the global bus 133 being arranged for coupling the multiplexer 131 and all distributed register file segments 109, 111 and 113, and conversion register file 115. The global bus 133 differs from the partially connected communication network 117 in that multiple functional units 101, 103 and 105, and type conversion unit 107 are coupled to the global bus 133 and these functional units and type conversion unit time-multiplex the global bus, whereas the partially connected communication network 117 couples one execution unit or the conversion unit to a register file segment or the conversion register file. An advantage of a global bus is that the overhead in terms of silicon area is relatively low when compared to a fully connected communication network.

The execution units or type conversion unit can be coupled to one register file segment, as in case of type conversion unit 107, or to multiple register file segments, as in case of execution unit 105, or multiple functional units may be coupled to one register file segment, as in case of the functional units 101 and 103. The register file segments can be coupled to one execution unit, as in case of conversion register file 115, or to multiple execution units, as in case of register file segment 109. The degree of coupling between the register file segments and the execution units can depend on the type of operations that the execution unit has to perform.

In the embodiment shown in FIG. 1, the partially connected network 117 and the communication device 129 share some resources, such as the multiplexers 119, 121, 123, 125 and 127. In other embodiments even more resources may be shared, or no resources are shared.

In other embodiments, the type conversion unit 107 may be part of one of the execution units 101, 103 and 105, and the register file segment 115 being part of the corresponding register file segment of that execution unit.

A superscalar processor also comprises multiple issue slots that can perform multiple operations in parallel, as in case of a VLIW processor. However, the processor hardware itself determines at runtime which operation dependencies exist and decides which operations to execute in parallel based on these dependencies, while ensuring that no resource conflicts will occur. The principles of the embodiments for a VLIW processor, described in this section, also apply for a superscalar processor. In general, a VLIW processor may have more execution units in comparison to a superscalar processor. The hardware of a VLIW processor is less complicated in comparison to a superscalar processor, which results in a better scalable architecture. The number of execution units and the complexity of each execution unit, among other things, will determine the amount of benefit that can be reached using the present invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A processor comprising:
a plurality of execution units (101, 103, 105);
a register file (109, 111, 113) accessible by the execution units;
a communication network (117) for coupling the execution units and the register file,
characterized in that the processor further comprises a conversion device (135) for converting the type of data when transferring said data between an execution unit of the plurality of execution units and the register file.

2. A processor according to claim 1, wherein:
the register file (109, 111, 113) is a distributed register file;
the communication network (117) is a partially connected communication network for coupling the execution units and selected parts of the distributed register file.

3. A processor according to claim 2, wherein:
the conversion device (135) comprise a conversion register file (115) and a conversion unit (107), the conversion register file being accessible by the conversion unit.

4. A processor according to claim 3, characterized in that the processor further comprises a communication device (129) for coupling the execution units (101, 103, 105), the conversion unit (107), the distributed register file (109, 111, 113), and the conversion register file (115).

5. A processor according to claim 4, characterized in that the communication device (129) supports all data types of a programming language.

6. A processor according to claim 4, characterized in that the communication device (129) couples all execution units (101, 103, 105), the conversion unit (107), all parts of the distributed register file (109, 11, 113), and the conversion register file (115).

7. A processor according to claim 6, characterized in that the conversion unit (107) is part of one of the execution units of the plurality of execution units (101, 103, 105).
